(19) United States
(12) Patent Application Publication
(10) Pub. No.: US 2006/0000946 A1
(43) Pub. Date: Jan. 5, 2006

(54) Secondary barrier system

(76) Inventors: Primo Garofani, Redwood City, CA (US); Dante G. Garofani, Redwood City, CA (US); Renato Garofani, Redwood City, CA (US)

Correspondence Address: TUE NGUYEN, 496 OLIVE AVENUE, FREMONT, CA, 94539, US

(21) Appl. No.: 10/849,333

(22) Filed: May 18, 2004

(51) Int. Cl. B64D 11/00

(52) U.S. Cl. 244/118.5; 52/64

(57) ABSTRACT

The present invention discloses a secondary barrier system with the same focus on public safety as well as the security of the secure area by providing both an extended secure area for the primary barrier, together with the functionality of an emergency exit, meaning it can be opened without much effort by the general non-skilled public in the event of emergency. The combination of secured barrier (to protect the primary barrier) and quick opening (in an event of emergency) of the present invention is accomplished by a special latch system. The special latch system in the present invention secondary barrier system is designed to require even the skilled intruder at least a few seconds to open, while allowing the non-skilled public only less than a minute. The less-than-a-minute opening time by the non-skilled public is acceptable for an emergency exit, while the more-than-a-few-second delay time is adequate for the close and securing of the primary barrier against an intruder breach. The present invention secondary barrier is well suitable for aircraft where public safety such as emergency exit is of comparable importance as security.

### FIELD OF THE INVENTION

This invention relates generally to a method and apparatus for creating a secondary barrier system and, more particularly, to a secondary barrier system protecting the aircraft cockpit.

### BACKGROUND OF THE INVENTION

All secure areas are normally protected by a primary barrier such as a locked door or a locked gate which is designed to effectively withstand the attack of intruders. However, a complete security design for a primary barrier needs to take into account the security issue when the primary barrier opens, which happens occasionally in the cases such as entering and exiting, changing guard, investigating outside disturbances, etc.

One example of a primary barrier protecting a secure area is the cockpit door in an aircraft. The security of this primary barrier is already improved with appropriate measures such as the installation of re-enforced cockpit door and security procedure, etc. However, there remains the need for improving the cockpit security when the cockpit door is open, for example, when the pilot needs to use the lavatory, which is located outside the cockpit and shared with the passengers, or when the flight attendant brings in food or beverage for the pilots.

The common approach to protect the secure area when the primary barrier is open is to create an extended secure area through a secondary barrier system. For example, in the above aircraft example, by creating a secondary barrier separating the passenger area and the lavatory, the lavatory and the cockpit become secure, and thus there is no possibility of security breach when the cockpit door is open.

Prior art discloses various secondary barrier systems, and many of them are particularly geared for aircraft. However, all prior art heavily stresses the security feature of the secondary barrier system and hardly consider the many side effects such as adaptability (in case of retrofit), suitability (in case of aircraft, the requirements of light weight, electrical components required approval for field interference, etc.), and practicality (failure rate of components, human error, etc.).

In particular, one feature that the prior art secondary barrier system neglects to consider is the need for public safety such as an emergency exit. For a proper secondary barrier design, the existence of an emergency exit in the newly created extended secure area should be of equal importance as its security. In the case of the aircraft for example, the emergency exit is located between the primary and secondary barrier systems. The secondary barrier system, located between the emergency exit and the passengers, thus needs to be able to be opened by a passenger quickly in an event of emergency and the exit path is required.

### SUMMARY OF THE INVENTION

The present invention discloses a secondary barrier system with the same focus on public safety as well as the security of the secure area. The present invention secondary barrier system, while providing an extended secure area for the primary barrier, can also be used as an exit door in an event of emergency, meaning it can be opened quickly without much effort by the general non-skilled public.

The combination of a secured barrier to protect the primary barrier and the effortless opening in the event of emergency of the present invention is accomplished by a special latch system. The special latch system in the present invention secondary barrier system is designed to require even the skilled intruder at least a few seconds to open, while allowing the non-skilled public only less than a minute.

By recognizing that the need for the extended secure area is not to protect the inner secure area (that is the job of the primary barrier) but only to allow time to close and secure the primary barrier, the security of the present invention secondary barrier is realized by delaying the intruders a few seconds before they can reach the opened primary barrier.

Also, by allowing the non-skilled general public less than a minute to open the secondary barrier, the barrier can be opened in an event of emergency to ensure the safety of the public.

The present invention secondary barrier is well suitable for public transport system such as aircraft, trains, or buses or public buildings where public safety such as emergency exit is of comparable importance as security.

### BRIEF DESCRIPTION OF THE DRAWINGS

FIG. 1 shows a schematic layout of an aircraft.

FIG. 2A shows the present invention secondary barrier system in its deployed state.

FIG. 2B shows the present invention secondary barrier system in its retracted state.

FIG. 3 shows the detailed assembly isometric view of present invention secondary barrier system.

FIG. 4 shows the present invention installed in an aircraft, looking from the cockpit door toward the passenger area.

FIG. 5 shows the same barrier in FIG. 4 in its retracted state.

FIG. 6 is a photograph of a test feature of the secondary barrier system in a commercial aircraft.

### DETAILED DESCRIPTION OF THE INVENTION

The present invention discloses a secondary barrier system with good security protection together with good public safety feature. The novel feature of the present invention is the combination of providing an extended secure area against intruder attacks and providing safe passage for the public in an event of emergency.

Normally, the area outside the primary barrier, which defines the inner secure area, is accessible by the public. Only when there is the need for opening the primary barrier that an extended secure area is established by the presence of the secondary barrier system. And therefore the structure is often not designed for the public safety when the secondary barrier system is erected. A perfectly secured secondary barrier would be overkill since the primary barrier is already adequate in protecting the inner secure area. And a perfectly secured secondary barrier would not provide any public safety since it is designed not to allow any access.

The present invention recognizes that the job of the secondary barrier could be defined in more than one way. Prior art secondary barrier system is designed to ensure that secondary barrier is as secure as the primary barrier so that when the primary barrier is open, the inner secure area is perfectly secured against any intruder attacks. This design is characterized by the strength of the secondary barrier, the fact that the secondary barrier is securely locked and the extended secure area is equipped with various means to fight intruders. There is no consideration of public safety when one chooses to define the secondary barrier this way, since if the secondary barrier needs to be as secure as the primary barrier, no pass-through is permissible, even in an event of emergency.

Yet there is another way to define the job of the secondary barrier. The secondary barrier could just be secure enough to provide the time needed to secure the primary barrier, since once the primary barrier is secure, the job is done. And from this perspective, the function of the secondary barrier is to delay the would-be intruder a few seconds so that the primary barrier can be closed and locked. The secondary barrier does not really need to hold off the would-be intruder for longer than the few seconds necessary to secure the primary barrier since once the primary barrier is secured, it is capable of guarding the inner secure area against any intruder attacks. The only requirement of this design is that the primary barrier is not left open un-attended, which should be the normal security procedure since it would be extremely difficult to protect an area having an open, un-attended security door.

From this perspective of functionality of a secondary barrier system, it is possible to design a secure secondary barrier that can provide the public safety measure in an event of emergency, meaning the secondary barrier can provide safe passage for the public during emergency.

Therefore the present invention discloses a secondary barrier capable of securing the inner secure area when the primary barrier is open, and at the same time can accommodate the public safety by providing safe passage through during an event of emergency. The secondary barrier of the present invention is designed to take at least a few seconds to no more than a minute to open. By requiring at least a few seconds to open, even for the most skilled persons, the present invention barrier fulfills its primary goal of securing the inner secure area by providing the needed time to secure the primary barrier. By requiring that no more than a minute is needed to open, even for the least skilled persons, the present invention fulfills its other goal of providing passage for the public in an event of emergency.

One embodiment of the present invention secondary barrier is a latch system capable of delaying a skilled person for at least a few seconds, and can be open even by a non-skilled person for no more than a minute, and preferably less than 30 or 20 seconds.

The latch system can comprise just one latch to secure the barrier. The handle of this one latch can be very small and awkwardly positioned to ensure of the needed few seconds requirement for operating the latch. The handle of this one latch can be multiply-covered (the handle is covered by one box whose access is covered by another box whose access is covered by another box, etc.). The number of covers can be experimentally determined and preferably is between 2 and 5. This one latch system can be positioned very near the floor to break the running stride of the would-be intruder, forcing the intruder to kneel down and fumble for the latch handle. The handle of this one latch can be positioned inside the extended secure area and cannot or very difficult to see from the outside, forcing the would-be intruder to reach through the barrier and guessing the location of the handle.

The latch system can comprise two latches to secure the barrier. The positions of these two latches can be far apart from each other, requiring some times to open both of them. Furthermore, these two latches can be interlocked, requiring both hands, or one hand and one foot, on the handles at the same time. Thus the two latches are preferably positioned as far as the reach of a typical person, at least 0.5 m, and preferably 1 to 1.5 m apart. The interlocked latches can be designed so that the two handles need to be operative at the same time, or that two handles need to be operative in sequence with one handle released before operating the other handle, or with one handle still holding in position before operating the other handle. The handle can have dummy operation, meaning it can move without operating the latch if the other handle is not ready to activate the mechanism.

The latch system can comprise more than two latches, but design must be taken into account the safe operation of the non-skilled public in emergency since more than two interlocked latches would be quite difficult to open.

To help with emergency operation, instruction manual for operation can be posted. Again, the posting could be in location that not readily observable, or being covered. It is preferable that it would take at least a few seconds of some maneuver before having access to the instruction manual.

Together with the latch system, the secondary barrier also would require structural strength to prevent brute force attacks. The barrier would preferably be allowed observation of outside activities, for example a barrier made of transparent materials such as strong plexiglass, or made of horizontal or mesh wires (metal wire, high strength fiber wire, etc.), or horizontal or mesh flat ribbons.

Adaptability of the secondary barrier is also an important feature. Many structures would require the retrofit of a secondary barrier, thus adaptability is critical in addressing many existing requirements. One embodiment of the present invention secondary barrier comprises a doorframe, a door and a latch system. The door is preferably retractable so that in open position (the secondary barrier system is activated) the door is retracted. The retracted door type could be a roll-up type, or a wire and pulley type, or a ribbon type. The doorframe is preferably an easily adaptable type such as the one with just the two posts. In other embodiment of the present invention, the doorframe might be omitted if the structure can provide some means to secure the door, such as the place to secure the door hinges, the locked latches. Using a retractable door, the barrier comprises essentially a doorpost and a frame. By securing the frame and extending or retracting the doorpost in the frame, an easily adaptable secondary barrier system can be accomplished.

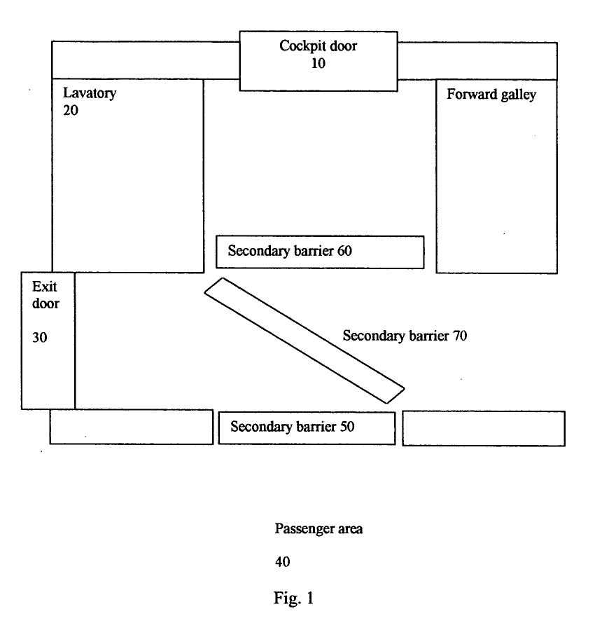

The present invention is well suitable for aircraft, boats, railroad cars or marine vessels. In an aircraft, the cockpit is a secure area with the cockpit door being the primary barrier. There is a great need for the establishment of a secondary barrier to create an extended secure area when the cockpit door is open, for example when the pilot needs to use the lavatory or when a flight attendant brings food or drink for the pilots. At one end of the aircraft is the passenger area, and there is a lavatory and an exit door between the cockpit and the passenger area. The secondary barrier is preferably established covering the lavatory or both the lavatory and the exit door. Depending on the existing structure of the aircraft, there might be different best locations. FIG. 1 shows the schematic layout of an aircraft, showing the cockpit door 10, the passenger area 20, the lavatory 30 and the exit door 40. The secondary barrier could be established at various locations, 50, 60 or 70, with location 50 seems to be best for the ease of adaptability.

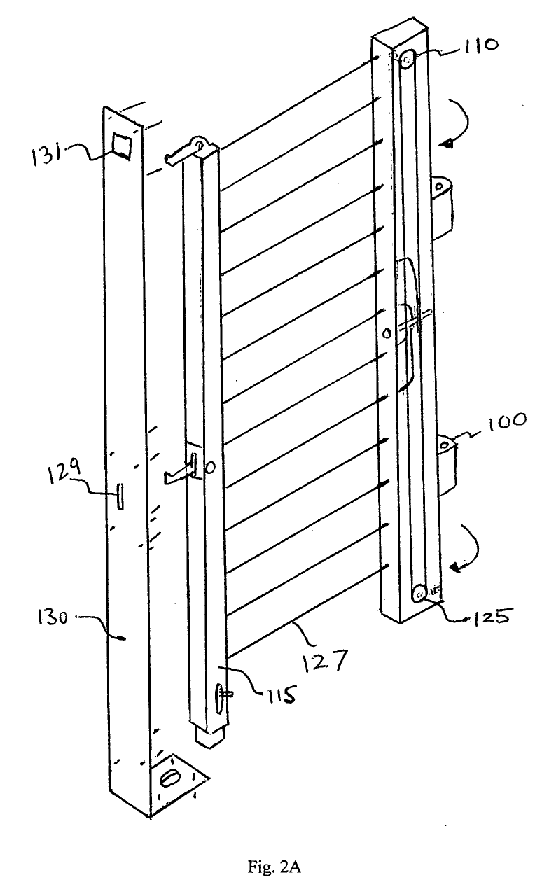

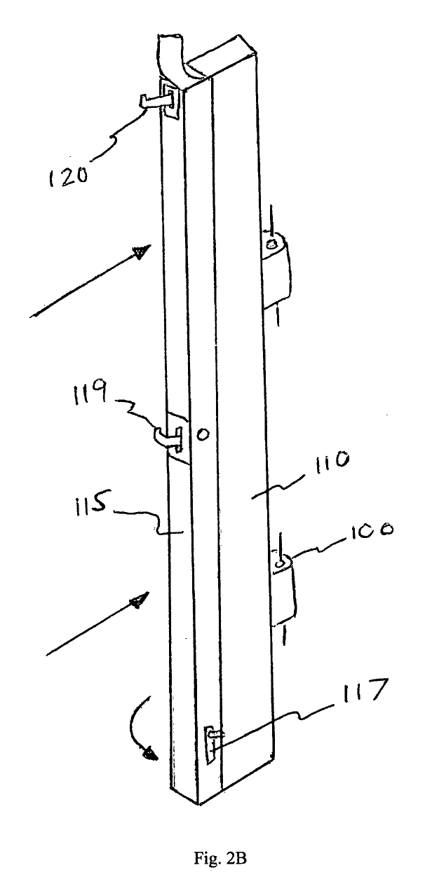

FIG. 2 show the present invention secondary barrier system in its deployed state (FIG. 2A) and its retracted state (FIG. 2B). The barrier comprises two frame posts (frame post 130 and another frame post 140 not shown in FIGS. 2 but shown in FIG. 3, attached to the hinges 100) to be securely attached to the aircraft, both at the walls and to the floor. The hinges 100 allow the barrier to swing into its deployed position, and swing back in its retracted state so that the barrier would not occupy much more of the doorway area than necessary when it is open. The barrier also comprises a retractable door having two posts 110 and 115, connected by steel wires 127 and retractable by a pulley system 125. The barrier system is secured to the frame 130 by a latch system comprising latches 117, 119 and 120, to be latched to frame 130 at positions 128, 129 and 131, respectively. Latch 117/128 is position at or near the floor to force the intruder to kneel down in order to open the latch. Latches 117 and 119 are interlocked to ensure the time delay of a few seconds. One needs to hold the latch 117 up while pulling on the latch 119 to have them opened at the same time. Latch 120 is to provide the added strength to prevent barrier breach due to brute force attack. In its retracted state, the door posts 115 and 110 are pulled together by a spring mechanism and the steel wires are retracted by the pulley system. The retracted door can swing outward to not blocking the doorway. FIG. 3 shows the detailed assembly isometric view of the present invention secondary barrier system with all the three latches engaged. The frame posts are preferably a thin sheet of metal as shown in FIG. 3 to ensure that the doorway opening is not compromised by the presence of the secondary barrier system. In it retracted state, the door swing outward, and only two thin metal sheets of the two frame posts are present in the doorway opening.

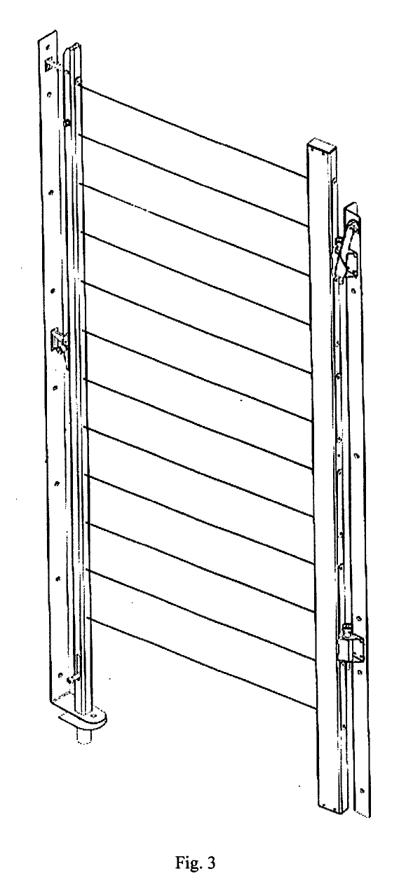

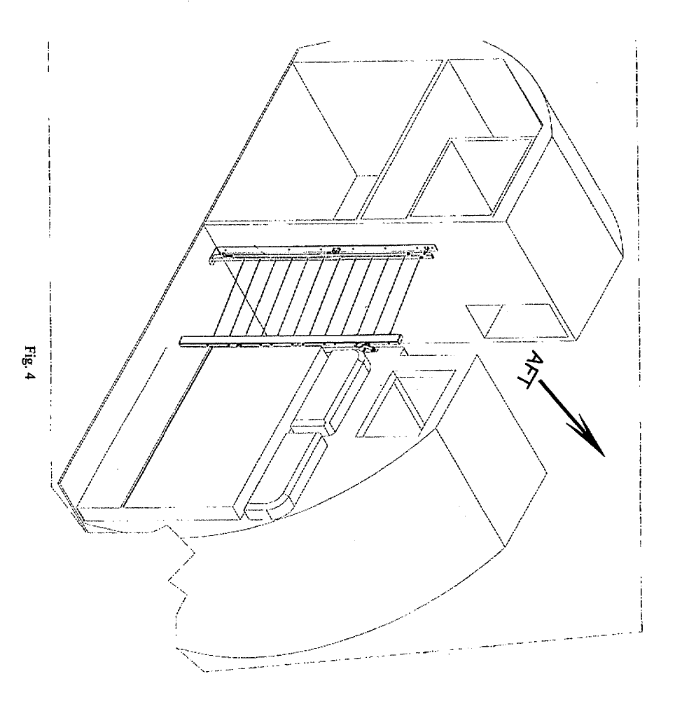

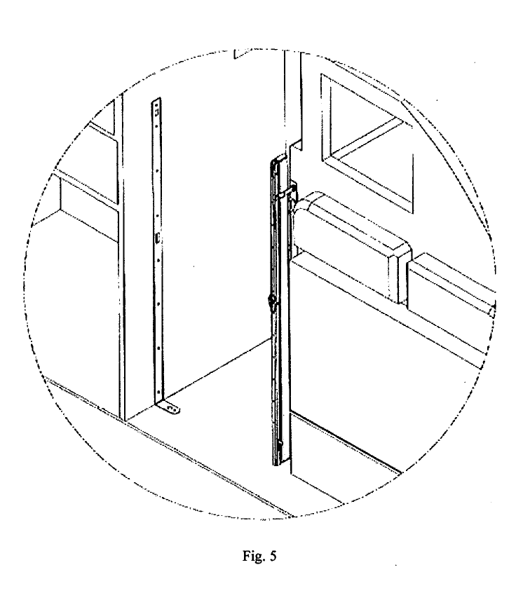

FIG. 4 shows the present invention installed in an aircraft, looking from the cockpit door toward the passenger area. The barrier is close, creating an extended secure area for the cockpit. The design allows visual inspection of the outside area from the cockpit. FIG. 5 shows the same barrier in its retracted state with the door swings outward. FIG. 6 is a photograph of a test feature of the secondary barrier system in a commercial aircraft.

Thus a novel secondary barrier system and its applications have been disclosed, together with the construction process. It will be appreciated that though preferred embodiments of the invention have been disclosed, further variations and modifications thereof may be made within the scope of the invention as defined in the appended claims. Further, although the invention has been described with reference to an aircraft for use with secondary barrier applications, other applications of the inventive concepts disclosed herein will also be apparent to those skilled in the art.

What is claimed is

1. A secondary barrier system in a structure to prevent intruder access to a primary barrier and to allow public pass-though in an event of emergency, the secondary barrier system comprising
a door structure; and
a latch system capable of securing the door structure to the structure, the latch system when engaged
being capable of delay a skilled intruder for at least an intruder-delaying time, the intruder-delaying time being adequate for securing the primary barrier; and
being capable of being opened by the non-skilled public for a reasonable emergency-delaying time, the emergency-delaying time being longer than the intruder-delaying time.

2. A barrier system as in claim 1 wherein the intruder-delaying time is 2 second or more and the emergency-delaying time is 30 second or less.

3. A barrier system as in claim 1 wherein the latch system comprises at least two latches spaced more than 0.5 meter apart.

4. A barrier system as in claim 1 wherein the latch system comprises at least two interlocked latches.

5. A barrier system as in claim 1 wherein the latch system comprises one latch positioned near the floor, whereby delaying the intruder by breaking the moving stride.

6. A secondary barrier system in a aircraft to prevent access to the cockpit door when the cockpit door is open and to allow public pass-though in emergency time, the secondary barrier system being light weight, high strength, and installed in the aircraft cockpit entrance way, comprising
a door having one end securely coupled to the aircraft; and
a latch system capable of securing the door to the aircraft, the latch system when engaged
being capable of delay a skilled intruder so that the cockpit door can be secured; and
being capable of being opened by the non-skilled public to allow for emergency exit.

7. A barrier system as in claim 6 wherein the latch system delays a skilled intruder for more than 2 seconds.

8. A barrier system as in claim 6 wherein the latch system delays the non-skilled public for less than 30 seconds.

9. A barrier system as in claim 6 wherein the door is a rolled up type door so that when it is retracted, it it is rolled into a cylinder shape.

10. A barrier system as in claim 6 wherein the door comprises a post having retractable wire, ribbon or mesh operated with a retractable mechanism.

11. A barrier system as in claim 10 wherein the retractable mechanism is a spring mechanism.

12. A barrier system as in claim 6 wherein the door allows light pass-through enabling the visual inspection of outside activities.

13. A barrier system as in claim 6 wherein the door and the latch system are structural solid to prevent break-through by impact.

14. A barrier system as in claim 6 further comprising a frame securely attached to the aircraft.

15. A barrier system as in claim 6 wherein the latch system comprises one latch with a latch handle covered by a time-consuming means to open.

16. A barrier system as in claim 6 wherein the latch system comprises at least two latches spaced more than 0.5 meter apart.

17. A barrier system as in claim 6 wherein the latch system comprises at least two interlocked latches.

18. A barrier system as in claim 6 wherein the latch system comprises one latch positioned near the floor, thereby delaying the intruder by breaking the moving stride.

19. A secondary barrier method to prevent intruder access to a primary barrier and to allow public pass-though in emergency time, the method comprising
establishing a barrier in the entrance way of the primary barrier; and
latching the barrier to secure the barrier, the latch system when engaged
being capable of delay a skilled intruder for at least an intruder-delaying time, the intruder-delaying time being adequate for securing the primary barrier; and
being capable of being opened by the non-skilled public for a reasonable emergency-delaying time, the emergency-delaying time being longer than the intruder-delaying time.

20. A barrier system as in claim 19 wherein the intruder-delaying time is 2 seconds or more and the emergency-delaying time is 30 seconds or less.
